(19) United States
(12) Patent Application Publication
(10) Pub. No.: US 2011/0265058 A1
(43) Pub. Date: Oct. 27, 2011

(54) EMBEDDABLE PROJECT DATA

(75) Inventors: Enzhou Wang, Bellevue, WA (US); Riyaz Habibbhai, Kirkland, WA (US); Marcin Sawicki, Kirkland, WA (US); Kevin J. Boske, Seattle, WA (US)

(73) Assignee: Microsoft Corporation, Redmond, WA (US)

(21) Appl. No.: 12/766,924

(22) Filed: Apr. 26, 2010

(51) Int. Cl. G06F 17/00; G06F 9/44; G06F 21/00; G06F 17/30

(52) U.S. Cl. 717/101; 715/234; 707/822; 707/706; 726/23; 707/E17.01; 707/E17.014

(57) ABSTRACT

Aspects of the subject matter described herein relate to embeddable project data. In aspects, project data corresponding to a project in a software development environment is encapsulated in a human-readable document(s). Data regarding project settings, folders, and items as well as relationship data is encoded in the document(s) such that the project may be reconstructed solely from the document(s). The document(s) may then be embedded in a host document (e.g., a document the project operates on) or otherwise as desired. When a host document is obtained, it may be scanned for embedded project data and additional actions may be performed based thereon.

### BACKGROUND

Some applications allow custom program code to control various features of the application. For example, a spreadsheet application may ship with or be associated with an editor that allows a system administrator, user, or the like to create custom code to operate on data in the spreadsheet. Conveying this code with the spreadsheet or other application in a way that the code may be easily understood and operated on is problematic.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to embeddable project data. In aspects, project data corresponding to a project in a software development environment is encapsulated in a human-readable document. Data regarding project settings, folders, and items as well as relationship data is encoded in the document(s) such that the project may be reconstructed solely from the document(s). The document(s) may then be embedded in a host document (e.g., a document the project operates on) or otherwise as desired. When a host document is obtained, it may be scanned for embedded project data and additional actions may be performed based thereon.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that generally represents an exemplary environment in which aspects of the subject matter described herein may be implemented;

FIG. 3 is a block diagram that represents an apparatus configured in accordance with aspects of the subject matter described herein; and

FIGS. 4-5 are flow diagrams that generally represent actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.” Other definitions, explicit and implicit, may be included below.

### Exemplary Operating Environment

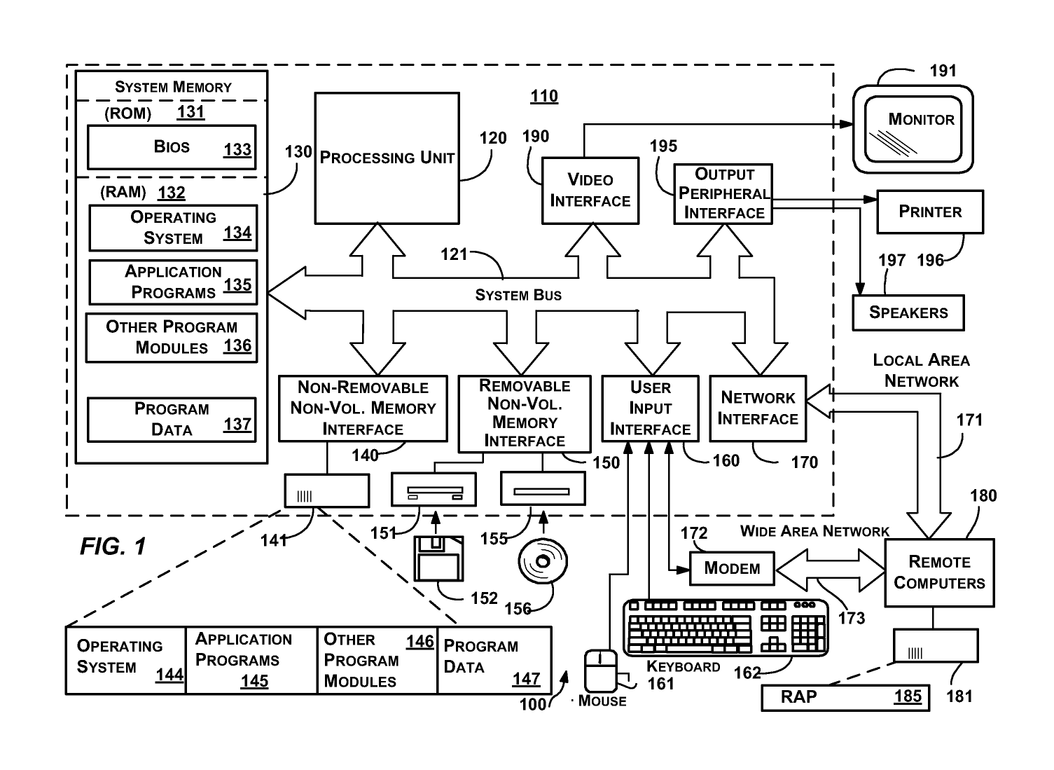

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Embeddable Project Data

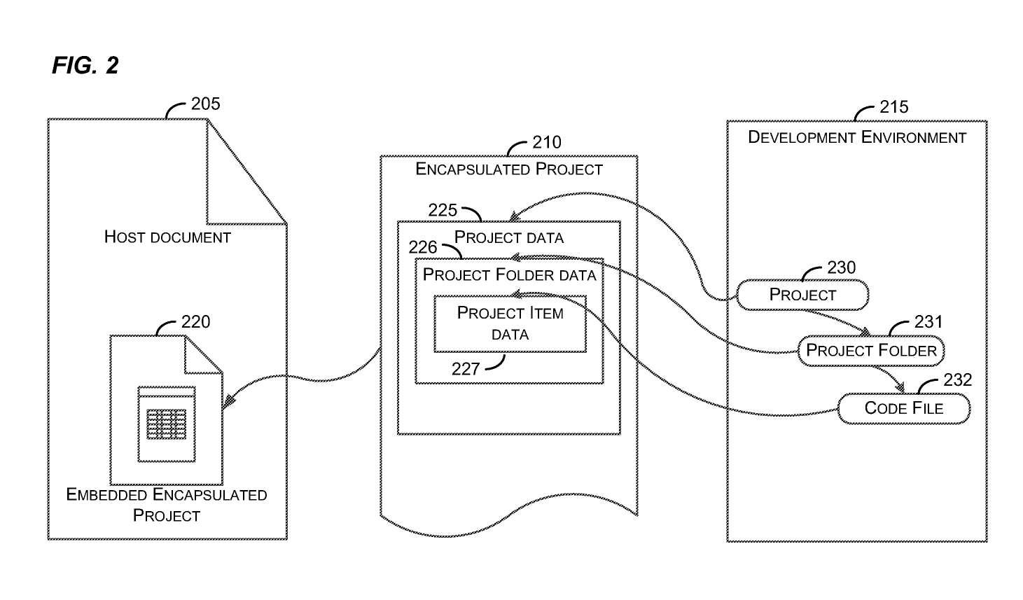

As mentioned previously, conveying code associated with an application in a way that the code may be easily understood and operated on is problematic. FIG. 2 is a block diagram that generally represents an exemplary environment in which aspects of the subject matter described herein may be implemented. The environment may include a host document 205, an encapsulated project 210, a development environment 215, and may include other entities (not shown). The development environment may include data that represents a project 230 that includes one or more project folders 231 and one or more code files 232. The encapsulated project 210 may include a user-readable representation of project data 225, project folder data 226, and project item data 227. The host document 205 may include embedded data corresponding to the encapsulated project 210.

The development environment 215 may include an editor, debugger, compiler, packager, and other software development components. The editor allows a software developer to create, modify, and delete code associated with a project. The debugger may allow the developer to debug the code. The compiler may compile source code into executable or intermediate code. The packager may package data corresponding to a project into a form of the encapsulated project 210.

The term data is to be read broadly to include anything that may be represented by one or more computer storage elements. Logically, data may be represented as a series of 1's and 0's in volatile or non-volatile memory. In computers that have a non-binary storage medium, data may be represented according to the capabilities of the storage medium. Data may be organized into different types of data structures including simple data types such as numbers, letters, and the like, hierarchical, linked, or other related data types, data structures that include multiple other data structures or simple data types, and the like. Some examples of data include information, program code, program state, program data, other data, and the like.

While working on software development including editing code, compiling, debugging, and otherwise, the development environment 215 may maintain the project 230 in one or more data structures. These data structures may be of a form that is readily usable by a program. For example, these data structures may include elements that are represented as one or more binary bits in a format suitable for processing by a processor.

On disk, the project 230 may reside in one or more project folders 231. Each project folder 231 may include data regarding one or more items. Items may include, for example, objects, workbooks, sheets, modules, classes, document pages, user interface objects, other items, and the like. An item may include code and may be stored in a code file such as the code file 232.

In generating the encapsulated project 210, a packager may gather data about a project such as project settings, data about the items included in a project, reference information, and the like. With this information, the packager may create a package of data (the encapsulated project 210) that includes the project data 225, project folder data 226, and project item data 227.

In one embodiment, this package of data may be formatted according to a markup language such as Extensible Markup Language (XML), HyperText Markup Language (HTML), or some other markup language. In another embodiment, this package of data may be encoded in a programming language. Just a few exemplary programming languages include C#, C, C++, Basic, Java®, Pascal, Fortran, assembly language, Perl, Python, PHP, Ruby, and Cobol. Based on the teachings herein, those skilled in the art may recognize many other programming languages into which the package of data may be encoded without departing from the spirit or scope of aspects of the subject matter described herein.

As used herein, the term “project definition language” refers to a text-based computer language that may be used to encode project data in a human-readable format. A text-based computer language has statements encoded predominantly with letters with perhaps some digits where the statements are meant to be understood by humans. A text-based computer language has a syntax that is unambiguous for a computer. A text-based computer language may include some 1's and 0's but does not consist solely of 1's and 0's. Text-based computer languages include markup languages, programming languages, and the like.

In contrast to a text-based computer language, a binary language refers to a language (e.g., a sequence of binary 1's and 0's) that is intended to be directly executed or operated on (e.g., without translation) by a virtual or physical computer. A text-based computer language may be translated into a binary language via a compiler.

Appendix A provides an exemplary package formatted according to an XML schema. The package included in Appendix A includes project configuration data (sometimes referred to as project settings), references, and a collection of items that include information about workbooks, sheets, modules, and classes. Source code for modules and classes are also included in the package of Appendix A. It is to be understood that Appendix A is exemplary only and is not intended to limit aspects of the subject matter described herein to spreadsheets, to the schema included in Appendix A, to XML, or to the particular package included in Appendix A.

A package may include multiple parts. As used herein, a part includes code (e.g., markup or other code) that may be included in a separate document from other parts. For example, instead of a package including a markup language document with a single root element and schema, the package may include multiple markup language documents with each markup language document having a different root element and different schema. For example, in one embodiment, various sections of the XML document included in Appendix A may have root elements other than <vsta:Project> and may be included in separate documents. Even when a package includes multiple parts, the parts may be grouped or otherwise related (e.g., in a hierarchy).

A package may be embedded in a host document (such as the host document 205). Some user documents may also be formatted in a markup language. When a host document format supports embedding, the package may be easily inserted into the document as one or more parts of the document. For example, the package provided in Appendix A may be inserted as one or more XML parts in a host document that supports embedding.

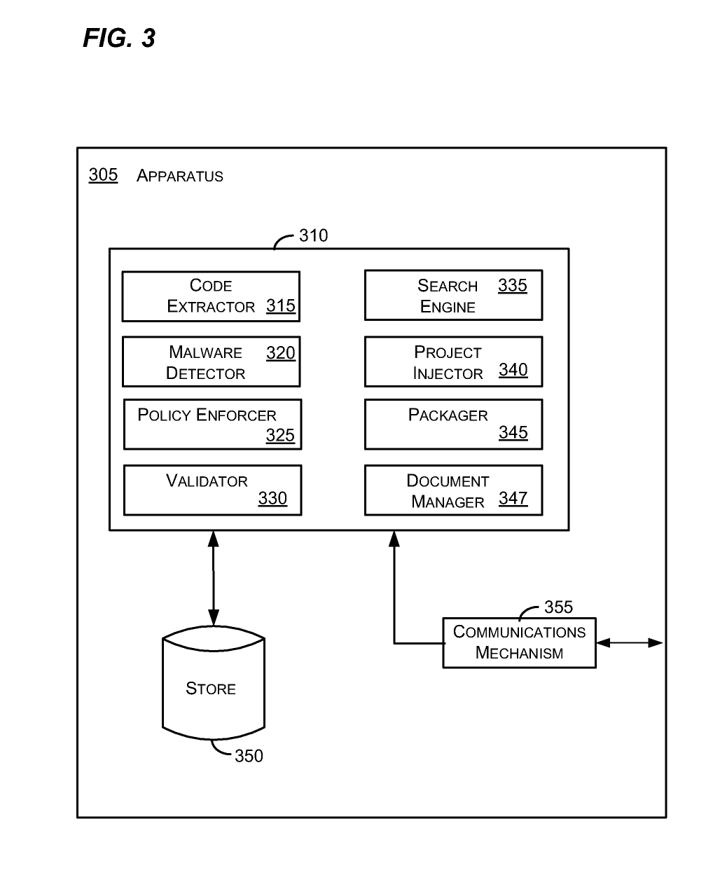

FIG. 3 is a block diagram that represents an apparatus configured in accordance with aspects of the subject matter described herein. The components illustrated in FIG. 3 are exemplary and are not meant to be all-inclusive of components that may be needed or included. In other embodiments, the components and/or functions described in conjunction with FIG. 3 may be included in other components (shown or not shown) or placed in subcomponents without departing from the spirit or scope of aspects of the subject matter described herein. In some embodiments, the components and/or functions described in conjunction with FIG. 3 may be distributed across multiple devices.

Turning to FIG. 3, the apparatus 305 may include project components 310, a store 350, a communications mechanism 355, and other components (not shown). The apparatus 305 may comprise one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act as the apparatus 305 comprises the computer 110 of FIG. 1.

The communications mechanism 355 allows the apparatus 305 to communicate with other entities. For example, the communications mechanism 355 may allow the apparatus 305 to communicate with a server that hosts documents that include encapsulated projects. The communications mechanism 355 may be a network interface or adapter 170, modem 172, or any other mechanism for establishing communications as described in conjunction with FIG. 1.

The store 350 is any storage media capable of providing access to encapsulated projects that encode projects. Access as used herein may include reading data, writing data, deleting data, updating data, a combination including two or more of the above, and the like. The store 350 may comprise a file system, database, volatile memory such as RAM, other storage, some combination of the above, and the like and may be distributed across multiple devices. The store 350 may be external, internal, or include components that are both internal and external to the apparatus 305. For example, the store 350 may be used to store an encapsulated project that is associated with one or more folders and one or more items. The encapsulated project may have hierarchical elements that correspond to the folders and items. The encapsulated project may be embedded in a host document that is formatted in the markup language (e.g., XML) of the encapsulated project.

The project components 310 may include a code extractor 315, a malware detector 320, a policy enforcer 325, a validator 330, a search engine 335, a project injector 340, a packager 345, a document manager 347, and other components (not shown).

The code extractor 315 may be operable to obtain source code from the document. For example, in Appendix A, the exemplary encapsulated project includes source code. The code extractor 315 may operate to obtain the source code from the encapsulated project. This source code may then be displayed to a user or used for other components (such as the malware detector 320, policy enforcer 325, or search engine 335).

The malware detector 320 may operate to detect viruses or other malware. For example, to be correct, an XML document conforms to a certain schema. One way to detect whether malware has been injected into a project that has been packaged into an XML document is to validate the XML document against the schema of the XML document. If the XML document is not correctly structured, this may indicate that the XML document has been tampered with. The malware detector 320 may employ the validator 330 to validate an XML document against a schema of the XML document.

As another example, certain operations (e.g., formatting a hard drive, installing files in certain locations, and the like) may be characteristic of malware. The malware detector 320 may detect these operations in a project and may use this information to determine that a project includes malware. Based on the teachings herein, those skilled in the art may recognize other activities that the malware detector 320 may take to detect malware without departing from the spirit or scope of aspects of the subject matter described herein.

The policy enforcer 325 may be used to enforce policies with respect to executable code that is included in a document. For example, an enterprise may have a policy that places restrictions on including executable code in a document. To enforce this policy, the policy enforcer 325 may scan documents. Documents that include an encapsulated project may be flagged for further processing. Such further processing may include removing the encapsulated project from the document, storing the removed project in a repository external to the document (e.g., a database, file system, or the like), and informing the user of the policy. Having a project encapsulated in a form like the one illustrated in Appendix A make enforcing this policy easier.

The validator 330 may operate to verify whether an encapsulated project follows a schema that indicates a valid structure of the encapsulated document. As mentioned previously, a markup language document may be associated with a schema. The schema may indicate an appropriate structure of the encapsulated document. If the encapsulated document does not have an appropriate structure, the document may be said to be invalid and this may indicate, for example, that the document has been corrupted or otherwise modified.

The search engine 335 may be used to search project data within an encapsulated project. For example, a system administrator may want to find projects that perform file I/O. To do this, the search engine 330 may examine documents to determine whether they include embedded projects. When a document includes an embedded project, the search engine 330 may search the project for source code that uses file I/O. The search engine 335 may utilize the document manager 347 to obtain parts of a project embedded in a document.

The document manager 347 may comprise a document management system or a portion thereof. The document manager 347 may be used to extract parts of the document, including the project data, for easier search and reuse in other documents, presentation in different views, or data mining purposes (including data mining the code of the project, for example, in search of certain programming constructs, patterns, or the like). The document manager 347 may also assemble documents upon demand and work with the project injector 340 to inject project data into such documents automatically, even if the project data was not in such documents originally. For example, the document manager 347 may assemble a document based on a user query or command.

As another example, a company's name may change. To find all code that references the old name, the search engine 330 may examine documents to determine whether they include embedded projects. When a document includes an embedded project, the search engine 330 may search the project for the old name. The search engine 330 may then provide a list of documents that include the old name. In one embodiment, the search engine 330 may replace the old name with the new name of the company.

The project injector 340 may be used to inject a project into one or more documents. For example, an enterprise may wish to have a custom set of macros available in documents of the enterprise. To accomplish this, a system administrator, developer, or the like may create the project and configure a server to inject the project into documents of the enterprise. Injection of the project may be triggered by one or more events such as opening the document, receiving the document in an e-mail, updating the document, or some other event.

The packager 345 may be operable to obtain data corresponding to the project from a development environment, file, or some other source and to encode the data into an encapsulated document. The encapsulated document may then be embedded in a host document or otherwise stored.

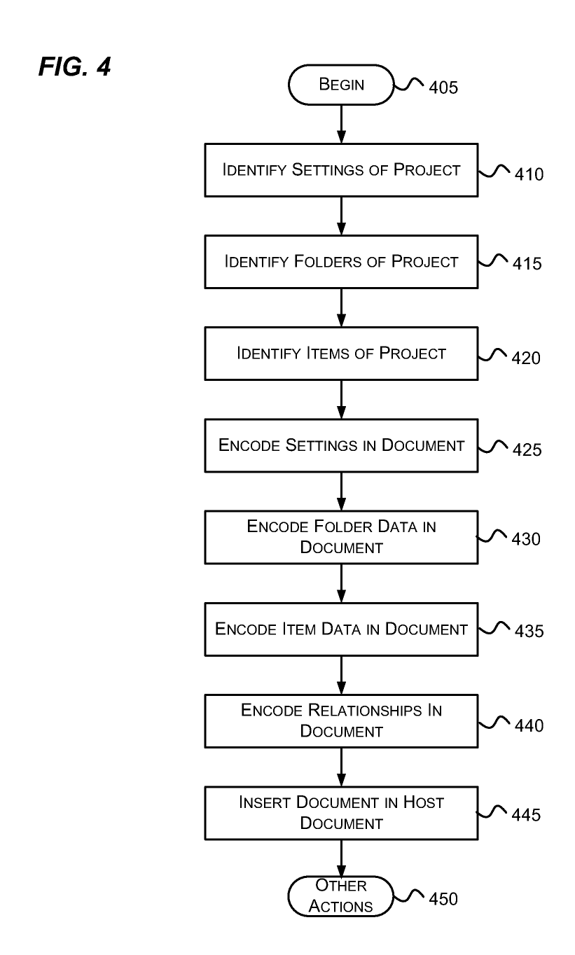

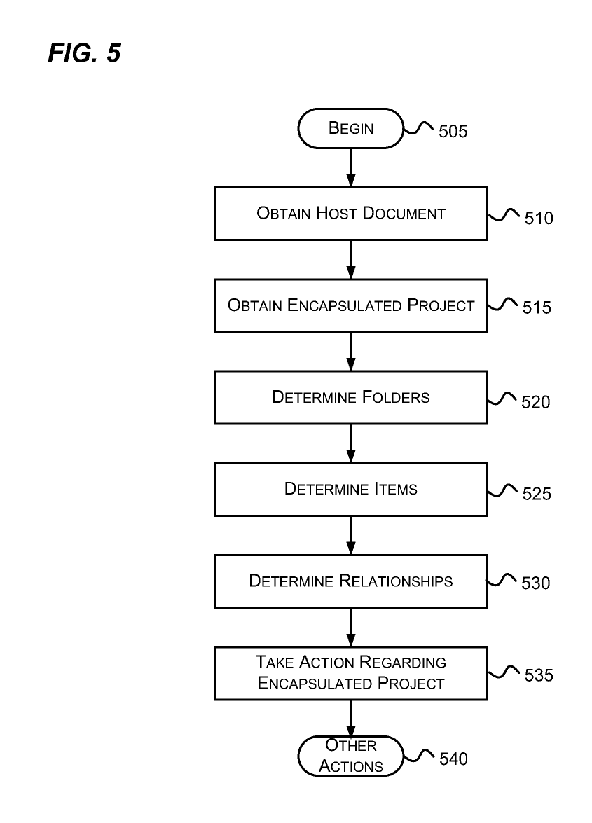

FIGS. 4-5 are flow diagrams that generally represent actions that may occur in accordance with aspects of the subject matter described herein. For simplicity of explanation, the methodology described in conjunction with FIGS. 4-5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 4, at block 405, the actions begin. At block 410, settings of a project are identified. For example, referring to FIG. 3, the packager 345 may identify settings in a project. For example, in Appendix A, these settings are included in the CDATA section beneath the <vsta:ProjectFileContent> tag.

At block 415, the folders of the project are identified. For example, referring to FIG. 3, the packager 345 may identify one or more folders associated with a project. As mentioned previously, these folders may correspond to file system folders that include various parts of the project.

At block 420, items of the project are identified. For example, referring to FIG. 2, the code file 232 may be identified. Identifying items of the project may include identifying, within the project, one or more classes, modules, document pages, objects, or a combination thereof (e.g., zero or more classes, zero or more modules, zero or more pages, and zero or more objects).

At block 425, the settings are encoded in the document. For example, referring to FIGS. 2 and 3, the packager 345 may encode the settings in the project data 225.

At block 430, data regarding the one or more project folders is encoded in the document. For example, referring to FIGS. 2 and 3, the packager 345 may encode data regarding the project folder 231 in the project folder data 226. Encoding this data may include, for example, encoding a name and identifier for each of the folders.

At block 435, data regarding the one or more items is encoded into the document. For example, referring to FIGS. 2 and 3, the packager 345 may encode data regarding the code file 232 into the project item data 227. Encoding data regarding the items may include encoding a name and identifier of each of the items. Encoding this data may also include encoding source code of one or more of the items.

At block 440, data regarding one or more relationships between the items and the project folders is encoded in the document. These relationships may comprise hierarchical relationships (e.g., items that are included in folders, folders that are included in the project, and so forth). For example, referring to the example given in Appendix A, this encoding may be performed by inserting items between tags associated with a folder. In other words, data regarding an item may be embedded in data of a project corresponding to the item.

At block 445, the document is inserted into a host document. For example, referring to FIGS. 2 and 3, the project injector 340 may insert the encapsulated project 210 into the host document 205. Inserting the encapsulated document into a host document may be performed in response to a request to open the host document prior to host document being provided to the requestor. This may be done, for example, to ensure that determined documents (e.g., word processing documents, spreadsheets, documents of a certain department, and the like) of an enterprise have a common set of macros inserted in them.

At block 450, other actions, if any, may be performed.

Turning to FIG. 5, at block 505, the actions begin. At block 510, a host document is obtained. For example, referring to FIGS. 2 and 3, the host document 205 may be obtained from the store 350, from an entity reachable from the communications mechanism 355, or from some other source.

At block 515, the encapsulated project is obtained from the host document. For example, referring to FIG. 2, the encapsulated project 220 may be located within the host document 205 by scanning through the host document 205.

At block 520, folders of the project are determined. For example, referring to FIG. 2, by scanning the encapsulated project 210, the folders involved in the project may be determined.

At block 525, the items of the project are determined. For example, referring to FIG. 2, by scanning each folder of the encapsulated project, items of the project may be determined.

At block 530, relationships are determined. These relationships may be determined by how the data is included in the encapsulated project. For example, item data may be included in certain folder data. This may indicate that the items of the item data are included in the folders. Relationships may also be specified in some other manner (e.g., by a tuple or the like in the encapsulated project that associates a folder with an item).

At block 535, an action regarding the encapsulated project is taken. For example, code may be extracted from the project, the project may be validated, a malware check may be performed, a search may be performed on the project data, a policy regarding the project may be enforced, source code of the project may be displayed on a display, a development environment may be configured using the project, or the like. For example, referring to FIG. 3, one or more of the project components 310 may take actions regarding the project.

At block 540, other actions, if any, may be performed.

As can be seen from the foregoing detailed description, aspects have been described related to embeddable project data in a document. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

1. A method implemented at least in part by a computer, the method comprising:
identifying one or more folders of a project used for software development;
identifying one or more items in the one or more project folders;
encoding project settings in a document formatted according to a markup language, the document having hierarchical elements corresponding to the one or more folders and items of the project;
encoding data regarding the one or more project folders in the document;
encoding data regarding the one or more items in the document; and
encoding data regarding one or more relationships between the one or more items and the one or more project folders in the document, such that the project is re-creatable solely from the document.

2. The method of claim 1, wherein encoding project settings in a document formatted according to a markup language comprises encoding the project settings in a document formatted according to an extensible markup language.

3. The method of claim 1, wherein identifying one or more folders of a project comprises identifying one or more file folders of a file system in which data of the project is stored.

4. The method of claim 1, wherein identifying one or more items comprises identifying, within the project, one or more classes, modules, and objects or a combination thereof.

5. The method of claim 1, wherein encoding data regarding the one or more project folders comprises encoding in the document at least a name and identifier for each of the project folders.

6. The method of claim 1, wherein encoding data regarding the one or more items comprises encoding in the document at least a name and identifier of each of the items.

7. The method of claim 1, wherein encoding data regarding the one or more items comprises encoding source code of at least one of the one or more items.

8. The method of claim 1, wherein encoding data regarding one or more relationships between the one or more items and the one or more project folders comprises, for embedding data regarding each item in data of a project folder corresponding to the item.

9. The method of claim 1, further comprising inserting the document in another document as one or more parts of the another document.

10. The method of claim 9, wherein inserting the document in another document is performed in response to a request to open the another document prior to the another document being provided to a requestor that sent the request.

11. In a computing environment, an apparatus, comprising:
a store operable to provide access to an encapsulated document that encodes a project, the project associated with one or more folders and one or more items, the encapsulated document formatted according to a markup language, the encapsulated document having hierarchical elements corresponding to the one or more folders and items of the project, the encapsulated document being embedded in a host document that is also formatted according to the markup language;
a validator operable to verify whether the encapsulated document follows a schema that indicates a valid structure of the encapsulated document; and
a code extractor operable to obtain source code from the encapsulated document, the source code relating to one or more of the one or more items.

12. The apparatus of claim 11, further comprising a search engine operable to search for data within the source code.

13. The apparatus of claim 11, further comprising a malware detector operable to scan the source code to search for malware contained therein.

14. The apparatus of claim 11, further comprising a policy enforcer operable to enforce a policy with respect to the project.

15. The apparatus of claim 14, wherein the policy enforcer being operable to enforce a policy comprises the policy enforcer being operable to remove the encapsulated document from the host document before allowing access to the host document.

16. The apparatus of claim 11, further comprising a project injector operable to insert the project into host documents prior to allowing access to the host documents.

17. The apparatus of claim 11, further comprising a packager operable to obtain data corresponding to the project from a development environment and to encode the data into the encapsulated document.

18. A computer storage medium having computer-executable instructions, which when executed perform actions, comprising:
obtaining a host document that includes an encapsulated project, the host document and the encapsulated project encoded according to a text-based computer language, the encapsulated project including project settings, folders, and items, the project having hierarchical elements corresponding to the folders and items;
obtaining the encapsulated project from the host document;
determining the folders from the encapsulated project;
determining the items from the encapsulated project; and
determining relationships between the folders and items from the encapsulated project.

19. The computer storage medium of claim 18, further comprising obtaining source code of an item and displaying the source code on a display.

20. The computer storage medium of claim 18 further comprising configuring a development environment using the encapsulated project.
